(19) United States
(12) Patent Application Publication
(10) Pub. No.: US 2025/0111325 A1
(43) Pub. Date: Apr. 3, 2025

(54) TECHNIQUES FOR A UNIVERSAL COMPLIANCE ENGINE

(71) Applicant: data phleet, Inc., Highland, UT (US)

(72) Inventors: RYAN LARSEN, Highland, UT (US); KEVIN KOGER, Springville, UT (US); LONNIE ELDRIDGE, San Diego, CA (US)

(73) Assignee: data phleet, Inc., Highland, UT (US)

(21) Appl. No.: 18/902,836

(22) Filed: Sep. 30, 2024

Related U.S. Application Data
(60) Provisional application No. 63/586,920, filed on Sep. 29, 2023.

(51) Int. Cl. G06Q 10/067; G06Q 10/0637; G06Q 10/0639; G06Q 50/06

(52) U.S. Cl. CPC G06Q 10/067; G06Q 10/06375; G06Q 10/06393; G06Q 50/06

(57) ABSTRACT

Various techniques are disclosed for a universal compliance engine. An apparatus is configured to parse one or more utility reliability standards to identify compliance requirements associated with a utility, create a compliance model based on the compliance requirements for each of the one or more utility reliability standards, determine utility data for a utility organization, the utility data associated with the compliance requirements, and generate one or more compliance tasks for the utility organization based on the compliance model and the utility data.

### CROSS-REFERENCE TO RELATED APPLICATIONS

This application claims the benefit of U.S. <<Provisional>> Patent Application No. 63/586,920 entitled “TECHNIQUES FOR A UNIVERSAL COMPLIANCE ENGINE” and filed on Sep. 29, 2023, for Ryan Larsen, et al., which is incorporated herein by reference.

### FIELD

This invention relates to compliance systems and more particularly relates to techniques for a universal compliance engine.

### BACKGROUND

Compliance management is crucial for utilities and other organizations that rely on agency approval to operate. However, keeping track of compliance tasks, inventories, requirements, and deadlines when the compliance tasks need to be performed and completed can be an overwhelming and painstaking task.

### BRIEF SUMMARY

In one embodiment, an apparatus is configured to parse one or more utility reliability standards to identify compliance requirements associated with a utility, create a compliance model based on the compliance requirements for each of the one or more utility reliability standards, determine utility data for a utility organization, the utility data associated with the compliance requirements, and generate one or more compliance tasks for the utility organization based on the compliance model and the utility data.

In one embodiment, a method includes parsing one or more utility reliability standards to identify compliance requirements associated with a utility, creating a compliance model based on the compliance requirements for each of the one or more utility reliability standards, determining utility data for a utility organization, the utility data associated with the compliance requirements, and generating one or more compliance tasks for the utility organization based on the compliance model and the utility data.

In one embodiment, a computer program product includes a computer readable storage medium storing code. The code is configured to be executable by a processor to perform operations including parsing one or more utility reliability standards to identify compliance requirements associated with a utility, creating a compliance model based on the compliance requirements for each of the one or more utility reliability standards, determining utility data for a utility organization, the utility data associated with the compliance requirements, and generating one or more compliance tasks for the utility organization based on the compliance model and the utility data.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for techniques for a universal compliance engine, according to the subject matter described herein;

FIG. 2 depicts one embodiment of a compliance apparatus for techniques for a universal compliance engine, according to the subject matter described herein;

FIG. 3 depicts one embodiment of a universal compliance engine for techniques for a universal compliance engine, according to the subject matter described herein;

FIG. 4 depicts one embodiment of an autonomous compliance entity for techniques for a universal compliance engine, according to the subject matter described herein;

FIG. 5 depicts one embodiment of an audit module for techniques for a universal compliance engine, according to the subject matter described herein;

FIG. 6 depicts one embodiment of a readable diagram for techniques for a universal compliance engine, according to the subject matter described herein;

FIG. 7 depicts one embodiment of tiered inventory analysis for techniques for a universal compliance engine, according to the subject matter described herein;

FIG. 8 depicts an embodiment of a method for techniques for a universal compliance engine, according to the subject matter described herein;

FIG. 9 depicts an embodiment of a method for techniques for a universal compliance engine, according to the subject matter described herein;

FIG. 10 depicts an embodiment of a method for techniques for a universal compliance engine, according to the subject matter described herein; and

FIG. 11 depicts an embodiment of a method for techniques for a universal compliance engine, according to the subject matter described herein.

### DETAILED DESCRIPTION

References throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

In one embodiment, an apparatus is configured to parse one or more utility reliability standards to identify compliance requirements associated with a utility, create a compliance model based on the compliance requirements for each of the one or more utility reliability standards, determine utility data for a utility organization, the utility data associated with the compliance requirements, and generate one or more compliance tasks for the utility organization based on the compliance model and the utility data.

In one embodiment, the apparatus generates a best fit model between the utility data for the utility organization and the compliance requirements. In one embodiment, the utility data comprises equipment data, inventory data, or a combination thereof.

In one embodiment, the apparatus generates compliance reports based on the one or more compliance tasks. In one embodiment, the apparatus calculates a confidence score for the compliance reports. In one embodiment, the apparatus performs documentation gap analysis to determine whether the generated compliance reports comply with documentation requirements for the utility reliability standards.

In one embodiment, the apparatus generates a compliance schedule for the one or more compliance tasks. In one embodiment, the apparatus initiates a compliance cycle based on the compliance schedule. In one embodiment, the compliance cycle has an associated tolerance level associated with completion of the compliance cycle.

In one embodiment, the apparatus queries personnel associated with the utility organization during the compliance cycle. In one embodiment, the apparatus dynamically adjusts the compliance schedule based on output from a previous compliance cycle and extrinsic compliance data.

In one embodiment, the apparatus reconciles missing utility data associated with the compliance requirements. In one embodiment, the apparatus generates a compliance audit response in response to an audit request. In one embodiment, the apparatus parses engineering diagrams as part of the one or more compliance tasks to identify utility equipment associated with the one or more compliance tasks.

In one embodiment, the apparatus verifies an accuracy of the parsed engineering diagrams and request additional information if the accuracy does not satisfy a threshold accuracy. In one embodiment, the apparatus incorporates custom classification data for the parsed engineering diagrams.

In one embodiment, the apparatus converts utility equipment information from the parsed engineering diagrams to match local utility equipment information. In one embodiment, the apparatus generates a catalog of utility equipment associated with each of the one or more compliance tasks based on one or more inputs.

In one embodiment, the apparatus dynamically adjusts a compliance cycle for a compliance task based on the catalog of utility equipment associated with each of the one or more compliance tasks.

In one embodiment, the apparatus generates an interactive engineering diagram based on the compliance model and the parsed engineering diagrams. In one embodiment, the apparatus generates one or more executable rules for the one or more compliance tasks, each of the one or more executable rules comprising one or more steps that trigger one or more actions for maintaining compliance with the one or more utility reliability standards.

In one embodiment, a method includes parsing one or more utility reliability standards to identify compliance requirements associated with a utility, creating a compliance model based on the compliance requirements for each of the one or more utility reliability standards, determining utility data for a utility organization, the utility data associated with the compliance requirements, and generating one or more compliance tasks for the utility organization based on the compliance model and the utility data.

In one embodiment, a computer program product includes a computer readable storage medium storing code. The code is configured to be executable by a processor to perform operations including parsing one or more utility reliability standards to identify compliance requirements associated with a utility, creating a compliance model based on the compliance requirements for each of the one or more utility reliability standards, determining utility data for a utility organization, the utility data associated with the compliance requirements, and generating one or more compliance tasks for the utility organization based on the compliance model and the utility data.

The electrical power grid that provides power to North America is a critical part of the U.S. and Canadian economies. The grid has been described as the “largest machine ever built” and, without its smooth operation, daily life as carried out by most could not continue. The reliable operation of this system keeps the economy moving; provides a safe lifeline to infrastructure such as hospitals, factories and home cooling and heating; and is a key element in the planned transition to electric vehicles.

However, a series of blackouts, including North America's worst blackout in history in August 2003, which caused over 50 million people to lose power in the northeastern U.S. and Canada, compelled regulators to impose a set of electrical reliability standards to which owners, operators, and other participants in grid functionality are held responsible.

The North American Electric Reliability Corporation (NERC) is responsible for developing and proposing the reliability standards, which are then approved by the Federal Energy Regulatory Commission (FERC) for use within the United States. NERC uses a stakeholder process to develop these standards with the participation of industry experts.

For instance, on Mar. 15, 2007, FERC approved 83 NERC Reliability Standards, the first set of legally enforceable standards for the U.S. bulk power system. This initial group of Reliability Standards became effective and enforceable on Jun. 4, 2007. The Standards are enforceable by penalties that can be quite severe-up to $1.2M or more per day per violation in the most egregious cases.

NERC's enforcement of these standards is carried out primarily through six Regional Entities. Each Regional Entity covers a specific geographic region. For example, the area of the western United States and Canada is enforced by the Western Electricity Coordinating Council (WECC). In enforcement, the Regional Entities perform functions including compliance monitoring, enforcement and mitigation, compliance audits, and providing training on compliance improvement.

Although technology in the electric power industry is advanced, it is also known to be a slower-moving industry, as reliability is seen as more important than new changes to the electric system. Further, the large cost and long timeframes needed to develop infrastructure causes utilities to maintain old equipment, often from many different manufacturers or design philosophies. In addition, utility practices often vary considerably from state to state or from region to region. For example, utilities in the northwest of the United States, such as the Bonneville Power Administration (BPA), produce high volumes of power from hydroelectric dams; in other regions, coal or natural gas production is more prominent.

In part because of the wide-ranging set of resources, equipment, practices, and state regulatory regimes, it has been difficult for utilities to comply fully with the Reliability Standards. Through an auditing and a self-reporting process, it is common for enforcement actions to be taken against utilities. For example, NERC reported that in Q1 of 2022 alone, it had imposed eleven penalty notices against several utilities that included 97 separate violations of the Reliability Standards.

Given the above situation, there is a need for innovation in energy utility compliance because utilities are having a difficult time ensuring compliance. Among their problems are tracking their assets that are subject to the Reliability Standards, ensuring that the Standards are continuously followed, and responding to audits competently and fully from the Regional Entities and from NERC, among others. Accordingly, this area has been identified as needing innovation to assist utilities in achieving compliance, which is ultimately of vital importance to sustaining and growing the electric grid.

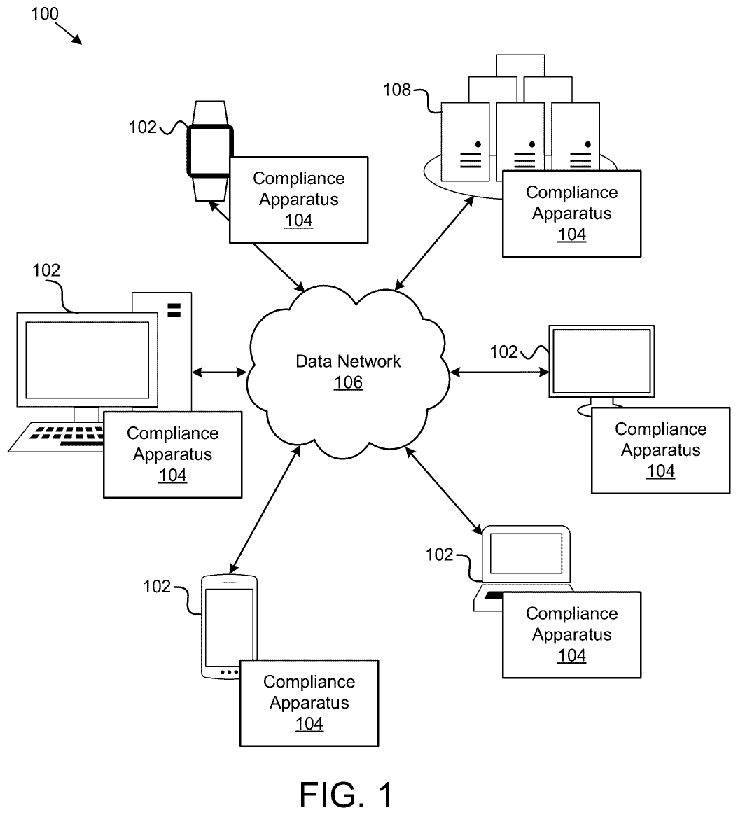

FIG. 1 is a schematic block diagram illustrating one embodiment of a system 100 for techniques for a universal compliance engine. In one embodiment, the system 100 includes one or more information handling devices 102, one or more compliance apparatuses 104, one or more data networks 106, and one or more servers 108. In certain embodiments, even though a specific number of information handling devices 102, compliance apparatuses 104, data networks 106, and servers 108 are depicted in FIG. 1, one of skill in the art will recognize, in light of this disclosure, that any number of information handling devices 102, compliance apparatuses 104, data networks 106, and servers 108 may be included in the system 100.

In one embodiment, the system 100 includes one or more information handling devices 102. The information handling devices 102 may be embodied as one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, head phones, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

In one embodiment, the compliance apparatus 104 is configured to create a compliance model for performing compliance tasks associated with the reliability standards. In certain embodiments, the compliance apparatus 104 parses one or more utility reliability standards to identify compliance requirements associated with a utility, creates a compliance model based on the compliance requirements for each of the one or more utility reliability standards, determines utility data for a utility organization, the utility data associated with the compliance requirements, and generates one or more compliance tasks for the utility organization based on the compliance model and the utility data. The compliance apparatus 104 is described in more detail below.

In certain embodiments, the compliance apparatus 104 may include a hardware device such as a secure hardware dongle or other hardware appliance device (e.g., a set-top box, a network appliance, or the like) that attaches to a device such as a head mounted display, a laptop computer, a server 108, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the compliance apparatus 104 may include a power interface, a wired and/or wireless network interface, a graphical interface that attaches to a display, and/or a semiconductor integrated circuit device as described below, configured to perform the functions described herein with regard to the compliance apparatus 104.

The compliance apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the compliance apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the compliance apparatus 104.

The semiconductor integrated circuit device or other hardware appliance of the compliance apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the compliance apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”) (e.g., a home network), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102 and may be configured to execute or run machine learning algorithms, programs, applications, processes, and/or the like.

In one embodiment, the reliability standards described herein follow a particular structure that includes several key components, each serving a different purpose in ensuring the reliability of the Bulk Electric System (BES) (as used herein, the term “BES” is essentially equivalent to the electrical grid). The main elements typically include:

Title: Each standard has a title that briefly describes its subject.

Number: A standard's identification number reflects its category and sequence within that category. For instance, in standard BAL-001-2, “BAL” stands for the category (Balancing), “001” is the sequence number, and “2” is the version number. “Balancing” is an activity that utilities undertake in “matching” their generation to the customer's loads in real time.

Purpose: The purpose of the standard briefly describes what the standard is intended to achieve in terms of maintaining or improving the reliability and security of the BES.

Applicability: This section defines who must comply with the standard, often defining entities by their roles in the BES such as Transmission Operator, Generation Owner, Reliability Coordinator, etc.

Requirements: The core part of each standard—these are the specific actions or conditions that the applicable entities must fulfill to comply with the standard. They are typically designated as “R” followed by a number (e.g., R1, R2).

Measures: These provide the evidence needed to demonstrate compliance with each requirement. These are typically designated as “M” followed by a number correlating to the related Requirement (e.g., M1 would provide evidence for R1). Measures might include specific reports, system data, logs, procedures, or other documentation.

Compliance: This section outlines the process by which compliance will be assessed, including the frequency of assessment, the types of audits or inspections that might be used, and the data retention policies.

Related Documents: This section includes any related standards, guidelines, regional variances, implementation plans, and other documents that might be relevant to understanding or complying with the standard.

Violations and Penalties: This section typically refers to NERC's Sanction Table, which provides a range of penalties for non-compliance with each requirement. Penalties are calculated based on several factors, including the risk to the BES, duration of the violation, and the size of the entity.

By following this structured format, the NERC/FERC reliability standards provide a framework for entities to ensure they are maintaining the reliability and security of the BES. Accordingly, due to the regular structure of these standards, the subject matter disclosed herein is directed to a compliance apparatus 104 that acts as a universal compliance engine (UCE) that leverages the commonalities in the reliability standards.

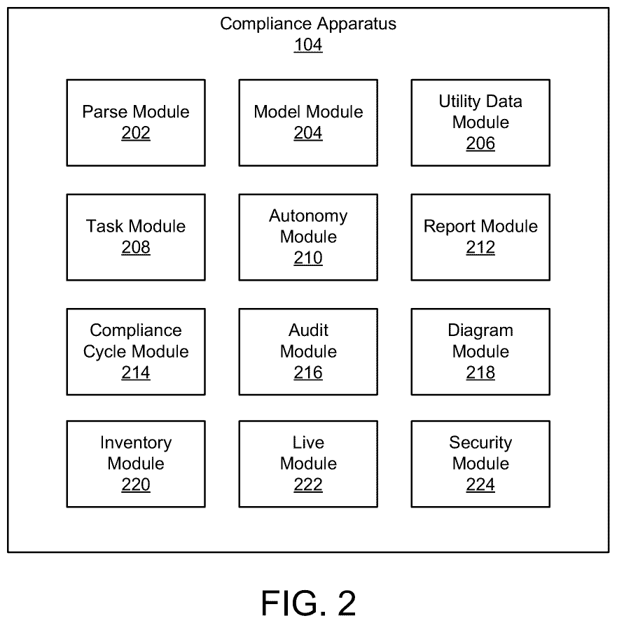

FIG. 2 depicts one embodiment of an apparatus for techniques for a universal compliance engine. The apparatus, in one embodiment, includes an instance of a compliance apparatus 104. The compliance apparatus 104, in one embodiment, includes one or more of a parse module 202, a model module 204, a utility data module 206, a task module 208, an autonomy module 210, a report module 212, a compliance cycle module 214, an audit module 216, a diagram module 218, an inventory module 220, a live module 222, and a security module 224, which are described in more detail below.

In one embodiment, a compliance apparatus 104, e.g., a UCE (also notated herein as dp: UCE), includes a parse module 202 that is configured to receive inputs (e.g., reliability standards as a PDF document, a text document, a spreadsheet, a webpage, or the like), parse the inputs and reduce the inputs to a series of compliance segments, modules, tokens, or the like (e.g., granular compliance instructions). These instructions are read into the UCE and a compliance model is created for each standard.

For example, the parse module 202 may receive a regulatory compliance manual as a PDF document that the parse module 202 processes using natural language processing, optical character recognition, or the like, to determine the compliance segments, modules, tokens, or the like. Similarly, in another example, the parse module 202 may scrape a webpage that displays the reliability standards to capture the text from the webpage and then process the text for compliance segments, modules, tokens, or the like.

In one embodiment, the model module 204 generates a compliance model based on the parsed reliability standards. The compliance model may be a learning model, a machine learning model, an artificial intelligence model, a mathematical model, or the like, that is trained on the reliability standards and used to process, forecast, or the like reliability standards for an enterprise, organization, utility, or the like. For instance, that compliance model may receive utility equipment information, enterprise information, site information, diagrams, or the like, as inputs and generate compliance schedules, tasks, requirements, and/or the like.

The model module 204 may train the compliance model using reliability standard information (e.g., manuals, webpages, text), output from previous compliance cycles, equipment and other utility data information, and/or the like. The compliance model may be any type of machine learning model including supervised learning models, unsupervised learning models, semi-supervised machine learning models, reinforcement machine learning models, and/or the like. Feedback from completion of compliance tasks and compliance cycles, described herein, may be used to refine the compliance model for increased accuracy and completeness.

In one embodiment, the utility data module 206 is configured to determine utility data for a utility organization, e.g., a power company. As used herein, utility data may refer to equipment data (e.g., model, type, serial number, or the like), site data (e.g., blueprints, site layout, building layout, or the like), control settings (e.g., parameters, variables, or other settings associated with equipment, processes, or the like), and/or the like. The utility data may be associated with a compliance requirement (e.g., checking a device, testing a device, and/or the like). The utility data module 206, in one embodiment, reads datafiles distributed throughout an enterprise, including and not limited to “one-line” and “three-line” engineering diagrams, relay settings, device logic and physical locations, manuals, among others.

In one embodiment, the utility data module 206 performs a tiered equipment identification that includes a hierarchical, multi-layer processing filter that identifies pieces of equipment through a stepwise process. In one embodiment, at a first layer, the utility data module 206 analyzes a variety of utility documents, such as schematics, network diagrams, or other documents by a custom machine learning model, including but not limited to the diagram reading techniques described herein. In one embodiment, the utility data module 206 uses or instructs the diagram module 218 to read the schematics. In one embodiment, the output of this layer is a database of identified equipment and associated characteristics, including device name, ID number(s), manufacturer, device type, style or model, and other attributes such as voltage, amps, resistance, RPM ratings, IP address and/or the like, depending upon the equipment type.

In the second layer, e.g., the “Inclusion Filter”, the utility data module 206 examines the output of the first layer more closely, reviewing for cases in which there is a lower confidence factor in the correspondence between intake data and the resulting device classifications. For example, the diagram review in Layer 1 may produce the result “resistor, 800 Ohms,” but the device's associated text (or label) may read differently, e.g., “800 Amps” or “Capacitor”. Another example of a potential discrepancy in Layer 1 would be a mismatch between the device identity, e.g., as determined by the line tracing logic versus a text label in close proximity on the diagram. The utility data module 206 at Layer 2 may then activate, instruct, command, or trigger the autonomy module 210 to either decide to accept the output of Layer 1 (when, for example, a certain confidence factor or threshold is satisfied or exceeded), or to request additional identification procedures, such as a UIRA (human expert request process) to establish the final classification of the item.

In one embodiment, the utility data module 206 at Layer 3 applies a filter of previously identified “local variations” in equipment labeling and classification, such as a particular way of drawing resistors or other power circuit elements (the “Local Filter”). The local filter is dynamically adjusted over time, as the utility data module 206 learns how the documentation represents certain power system elements or particular ways in which equipment is drawn or labeled by the utility or its engineers.

A challenge faced by compliance auditors is matching devices from a schematic to devices listed in a settings file, a test maintenance record, or any of a number of other file types. In one embodiment, the utility module 206 includes a label engine, e.g., as part of the inclusion filter. In one embodiment, the label engine serves many purposes, one of which is to convert the text processed from schematic drawings into device identifiers that match the device identifiers in settings, test and maintenance, and other documents. For example, a CT may be labeled using only the power ratio for the device, such as 3000/5, followed by the number of CTs in that set. Another draftsman may label the CTs with the identification of the device that the CT is connected to in the circuit, followed by its ratio. Such a device may be labelled as F12 3000/5 (3). Other draftsmen may include the manufacturer or model number or device the CT is associated with in the label. The utility module 206 uses the label engine to take the available information for a given device, along with relevant information from nearby devices like generators or phase labels, and iterate through common label patterns and attempt to match the resulting label with information from the settings files and test records.

The task module 208, in one embodiment, is configured to determine one or more compliance tasks for a utility organization to maintain compliance according to the reliability standards, using the compliance model and the utility data. As used herein, a compliance task may refer to a step, a series of steps, a process, and/or the like to be completed to be compliant with a reliability standard. The compliance task may be associated with verifying that equipment, rules, regulations, processes, or the like are compliant with a standard. In one embodiment, the compliance apparatus 104, after analyzing, processing, or the like, the compliance requirements of a reliability standard, generates a “best fit” between the compliance requirements and the utility data in the enterprise. The compliance model may continuously adjust, update, refine, or the like the output of this best fit.

In one embodiment, the task module 208 generates rules for completing a compliance task. The task module 208, for instance, maintains a bank of logical flow steps that are required to complete compliance tasks and maintain compliance with each reliability standard. Some compliance requirements of the reliability standards have regional variations, in addition to global requirements as well as local requirements. Some of the flow steps for each reliability standard are shared among the various reliability standards, where there is commonality. Others are read from compliance configuration files. When a rule is “run,” it can prompt the utility to take certain actions, such as data gathering, equipment replacement, data logging, and so on. When the audit module 216, described below, runs an audit cycle (which may involve one or more reliability standards), each compliance routine, rule, or task may continue to run in the background. The audit cycle may leverage the compliance steps (and the output of these steps) for each Standard to complete a real or simulated audit. Ongoing workflow for each reliability standard may be controlled by the autonomy module 210, described below, and UIRA queries for human data acquisition or approval may be selected for each reliability standard. Optionally, the task module 208 operates autonomously, and the human operator will not be queried. The level of autonomous operation can be configured.

As terminology and inventory classification varies widely by particular utilities (for example, there are over 10 major manufacturers of steam turbines in common use, and many more historical examples still in operation, each with a variety of model designations), in one embodiment, the compliance apparatus 104 may not at first associate a particular model name or number with the Reliability Standards classification of the required equipment (e.g., a “Generator”).

In one embodiment, the compliance apparatus 104 includes an instance of an autonomy module 210. The autonomy module 210 (e.g., dp: ACE), in one embodiment, is embodied as a bot (e.g., a virtual assistant, a chatbot, or the like) that is configured to interact with utility personnel and the compliance apparatus 104, e.g., the compliance model. In one embodiment, through this interaction, the compliance model learns over time to associate particular utility data, e.g., utility equipment and inventory lists, with particular classifications in the reliability standards. In one embodiment, the autonomy module 210 also runs an automated inventory assessment (AIS) described herein.

In one embodiment, the autonomy module 210 performs functions, processes, or the like related to robotic process automation (RPA), artificial intelligence (AI), and/or machine learning (ML). As used herein, AI may refer to the general ability of computers to emulate human thought and perform tasks in real-world environments. ML is a subset of the broader category of AI and may refer to the technologies and algorithms that enable systems to identify patterns, make decisions, and improve themselves through experience and data. Further, as used herein, RPA may refer to processes, programs, application programming interfaces (APIs), and/or the like that utilize AI/ML to create and utilize intelligent “bots” for automating tasks.

In one embodiment, the autonomy module 210 may utilize RPA or other AI/ML processes to perform various regulatory (NERC) compliance tasks such as reading/processing regulatory information, searching/comparing information to identify discrepancies, creating documentation, notifying users of potential compliance issues, remediating and performing re-audits for compliance, and/or the like.

In one example embodiment, the autonomy module 210 can parse a stream of data, either internal or external to the utility's systems, using a series of extensible parse criteria. The parse criteria can grow over time, and weights or importance levels can be attached to each criteria set, through machine learning and artificial intelligence algorithms. Criteria may include, but are not limited to, weather data (past, present, and future); equipment status updates; global geopolitical data (as may affect, for example, supply chain availability of equipment or software); financial filings of supply chain related companies, and other data.

After parsing the data using the extensible parse criteria, the autonomy module 210 can create a list of action items, such as running a compliance cycle, triggering anticipatory compliance activities, requesting UIRA input from users, among other actions. Through this list, actionable intelligence is created that the autonomy module 210 or utility personnel can act upon. The autonomy module 210 can also associate the appropriate weights (which may be multi-dimensional) to particular criteria, as well as setting cutoff levels for particular actions. Thus, potential compliance issues due to conditions (internal, external, or otherwise) affecting the criteria can be anticipated, allowing the utility to take early or more effective action to maintain compliance under the reliability standards.

In one embodiment, the compliance apparatus 104 includes an instance of a report module 212 that is configured to generate compliance reports based on the compliance tasks. For instance, after processing the reliability standards and utility data, the compliance apparatus 104 can generate internal and external reports required for the Measures (“M”) and Compliance (“C”) sections of the reliability standards. The report module 212 can set time-sensitive requirements or reports to re-occur upon required intervals or as instructed by the autonomy module 210 and/or utility personnel.

In certain embodiments, the report module 212 calculates a confidence score for the compliance reports. The confidence score may indicate the likelihood that the report is accurate, complete, thorough, or the like or the likelihood that the report is deficient, missing information, and/or the like. The report module 212 may use the compliance model, or another machine learning model, to calculate the confidence score for a report (based on various factors that the compliance model is trained on including previous reports, compliance data, utility data, or the like.

In one embodiment, the report module 212 calculates a confidence score using a multi-variable function that includes an extensible input data set. The variables utilized as input to the confidence score function include, but are not limited to, the accuracy of the symbol or diagram review, how current the utility's compliance cycles are, the “tolerance level” set for the running of the compliance reports, historical comparison of accuracy of reports by the utility for the particular reliability standards involved, system age and maintenance records, and prior NERC/FERC audit results for the relevant standards, among other factors. The confidence score function, under one implementation, is from one to five, with 1 being the lowest confidence score and 5 being the highest. Each input variable to the confidence score function is given an independent 1 to 5 value, and they are averaged with a weighting function to produce an overall confidence score (which can optionally be displayed on a 100% scale, rather than 1 through 5). The report module 212 may adjust the weighting function through an optimization algorithm over time as feedback is received regarding the accuracy of the confidence score.

In one embodiment, the report module 212 performs document gap analysis to determine whether there are gaps in the generated reports that are required for a compliance task. For instance, during a compliance cycle, the compliance apparatus 104, the autonomy module 210, and/or the report module 212 is aware of the documentation requirements for each reliability standard. These documentation requirements are primarily set forth in the Measures (M) portion of each reliability standard, but other documentation requirements can also be found in the compliance (C) portions, and in other areas of the reliability standards as well. The required documentation can take several forms, including event analysis reports, equipment settings, load forecasting documents, asset management records, emergency response plans, and a variety of other formats and structures.

In such an embodiment, the compliance apparatus 104, the autonomy module 210, and/or the report module 212 creates a comprehensive set of the documentation requirements expressed in each reliability standard as they are parsed and encoded, as described above. The autonomy module 210 may compare the documentation found in the utility for the particular reliability standard with the applicable requirements and perform a documentation gap analysis. This documentation gap analysis can then be used for several purposes, including keeping utility personnel up to date with deficiencies in their documentation, as well as the initiation of a documentation improvement cycle. Under the improvement cycle, the autonomy module 210 initiates an improvement process by querying human utility personnel and instructing them to locate or create the additional documentation, as appropriate. The autonomy module 210 can also analyze which of the missing documentation pieces can be created by the report module 212. If the report module 212 contains sufficient information to produce a report, for example, on relay settings that it has learned through analyzing the utility's data, the autonomy module 210 can then create a proposed report to be then reviewed and approved by a human operator.

In one embodiment, compliance apparatus includes a compliance cycle module 214 that is configured to interact with the compliance model and with utility personnel, or other automated agents to generate and initiate a compliance cycle for one or more Reliability Standards. As used herein, a compliance cycle may refer to a schedule, pattern, process, or the like that is used or executed periodically or continually to verify compliance with a reliability standard.

In such an embodiment, the compliance cycle module 214 sets or determines (e.g., received from a user, read from a storage location, or the like) a tolerance level as it attempts to run a compliance cycle, which may include a check for spot compliance with a reliability standard (and optionally, with appropriate reporting such as a compliance assessment report (CAR), or a NERC Reliability Standard Audit Worksheet (RSAW)).

In one embodiment, the tolerance level sets the amount of details that are provided in audit results. If the tolerance level is set low, in one embodiment, a compliance cycle may fail, with one or more failure notices. Further, the audit results may not be produced unless a threshold number of predicates are present (e.g., each of a set of predicates) and a compliance deficiency list is produced. At a mid-range or middle tolerance level, audit results are generated if at least a subset of predicates exist. At a higher tolerance level, the compliance cycle may be completed, but with annotations indicating which assumptions were made (e.g., that a particular piece of equipment was of the type being sought but not found) and audit results may be generated in all situations. To complete an audit, in one embodiment, there may be several required pieces of information or predicates, and the tolerance level may indicate how the compliance cycle module 214 handles missing or incomplete predicates, e.g., attempts to fill them in using machine learning/artificial intelligence, defaults to predefined values, sends a notification or error message, and/or the like.

In one embodiment, the autonomy module 210 and/or the compliance cycle module 214 queries utility personnel during a compliance cycle as it looks for or seeks information associated with utility data, compliance data, or the like, e.g., via an interface or electronic message. The information may be received in a structured data format or in natural language using a large language model (LLM) and/or utilizing the compliance model. This human focused query may also be termed a User Input Required Alert (UIRA). The autonomy module 210 and/or the compliance cycle module 214, in one embodiment, learns over time which human respondents (e.g., employees, directors, administrators, or other staff) are likely to have the type of information being requested, e.g., by measuring response times, accuracy, or the like. Without knowing the expertise of particular personnel, the autonomy module 210 and/or the compliance cycle module 214 can also include a “suggestion” response through which the human participant can suggest other persons or databases that might contain the information that is sought in order to complete a compliance cycle. This suggestion information may be logged and incorporated into future queries. In some embodiments, the autonomy module 210 and/or the compliance cycle module ensures a distributed workload of UIRA queries to human personnel, spreading queries among qualified respondents. In one embodiment, whether user interaction is sought during a compliance cycle is determined based on a user-defined flag, which indicates whether the compliance cycle will be run with or without user interaction.

In one embodiment, the autonomy module 210 and/or the compliance cycle module 214 produces textual results, including natural language results, in several ways. It can report to utility personnel in response to natural language queries about the state of the utility's compliance program through data sets (e.g., such as a spreadsheet), extensible text templates, or by the use of an LLM. The NERC reliability program may include RSAW forms so that utilities can document compliance and provide certain explanations, which the autonomy module 210, the report module 212, and/or the compliance cycle module 214 may use. The combination of extensible form text data along with LLM natural language generation allows a complete RSAW (which may be comprised of both data points, such as voltage measurements, and natural language explanations) to be fully completed.

In one embodiment, the autonomy module 210 and/or the compliance cycle module 214 adjusts recommended compliance cycle times based on the output of a previous compliance cycle (that is, the degree of compliance with the relevant reliability standard), along with other extrinsic data outside of the compliance cycle, such as weather patterns (which may affect the functioning or reliability of certain equipment), trends in other reliability standards in the utility (or abstracted from other utilities), equipment age, manufacturer bulletins and recalls, fines levied historically, the overall cost of a compliance cycle, and/or the like.

For example, if a compliance cycle would ordinarily have a one-year time period, the autonomy module 210 and/or the compliance cycle module 214 may recommend a shorter cycle based on a function of those variables to, among other outcomes, mitigate risk and improve internal controls. Further, the autonomy module 210 and/or the compliance cycle module 214 can be instructed to operate in a “community decision” mode, where the autonomy module 210 and/or the compliance cycle module 214 first makes a recommendation to shorten (or lengthen) a compliance cycle and transmits this recommendation to a pre-selected group of utility operators through the user input required alert (UIRA) process. If the polling of the human operators results in a majority or other threshold (up to unanimity) agreeing with the proposal for a new compliance cycle timeline, the new compliance cycle timeline will be implemented.

In one embodiment, the audit module 216 generates context-dependent audit responses. Utilities are periodically audited, e.g., by the regional entities (REs), to ensure compliance with reliability standards. When faced with potential penalties in an audit finding, for instance, the utility may respond in such a way as to take into account the historical context of the interaction with the auditing RE. These responses by the utility may be in reply to a notice of alleged violation, in a mitigation plan, settlement, or other venue. In the context-dependent audit response mode, text in a utility is classified with a code indicating whether it is text from the RE, NERC, a notice of penalty, a settlement, or other reliability document.

In one embodiment, the audit module 216 inserts tagged text segments into an LLM before a response is generated, to create a context-dependent text, generated by the LLM and suitable for filing with the RE that takes into account previous violations. In one embodiment, the audit module 216 and/or the autonomy module 210 includes an internal stepwise protocol where a number of encoded compliance steps [S1, . . . Sn] for a compliance task that corresponds to the various elemental intermediate steps of an audit are performed. In one embodiment, the audit module 216 attempts to reconcile incomplete or potentially missing utility data that is critical to compliance with the reliability standards, e.g., using machine learning, user input, a best guess, an estimate, and/or the like.

In one embodiment, in a Simulated Audit Mode (SAM) (e.g., a mock audit), the audit module 216 selects a random number of compliance standards (from, for example, 1 to n, where n represents a maximum percentage of the applicable standards) and generates a series of simulated audit requests. In such an embodiment, the audit module 216 prompts the human users with audit requests, while simultaneously responding to the users' directions as the simulated audit is carried out. The audit module 216 may then report on the results in specified data formats, structured text, or natural language.

In one embodiment, the audit module 216, may use SAM mode for training purposes, so that utility personnel can become familiar with the standards and the compliance cycle. In one embodiment, the SAM mode simulated events can be tailored to the most likely or known failure events in the particular equipment or configuration of a particular utility. In one embodiment, the audit module 216 can also load simulated data and non-specific client schematics as part of an abstracted universal utility data (UUD) set for training exercises. The UUD may include equipment settings and maintenance data.

In one embodiment, the audit module 216 provides a secure audit container where the audit module 216 can produce a time-stamped, public-private key pair stamped (or distributed-ledger or blockchain stamped) set of evidence supporting a NERC required reporting format. One example of this format is the RSAW. This evidence is guaranteed by the public-private key pair stamping to be unmodified since the time the particular RSAW was generated.

In one embodiment, the diagram module 218 is configured to “read” engineering diagrams, including but not limited to one-line/three-line power system diagrams and other various diagram types, using machine learning, optical character recognition, image processing, or the like. To do this, in one embodiment, the diagram module 218 identifies symbols that correspond to equipment in the utility's reliability equipment inventory. For an electrical utility, for example, common symbols may include generators, transformers, relays and transmission lines. These diagrams may include information, settings, parameters, and/or other data regarding the equipment they depict. For example, electric relays commonly include numerical designations for their under- and over-frequency “tripping” (circuit-breaking) settings. The diagram module 218, in one embodiment, identifies the symbols in an automated fashion and uses an “increasing radius” method to search for and read appropriate numerical and mathematical symbols in proximity to each diagram element.

In one embodiment, when the diagram module 218 parses the symbols, they are matched with symbols that are known to be associated with an equipment type, e.g., cross referencing with a list, table, database, or the like of equipment type and symbols. If there is low confidence or errors in the applicability of the parsed information, the diagram module 218 can note a failure, send a message, or request that the autonomy module 210, e.g., a bot, send a User Information Request Alert (UIRA). A human can then assist in a portion of the diagram that is indicated, as necessary. This collaborative method of reading diagrams provides an efficient advantage for ensuring compliance with the reliability standards. Further, the diagram module 218 can read variations of the symbols, including whether they are rotated, using image recognition and, after confirmation, machine learning as the diagram module 218 creates an inventory of symbol variations. In one embodiment, through the UIRA process, the diagram module 218 calculates or generates a confidence factor (a numerical measurement of accuracy) associated with the parsing of symbols and diagram features. For example, based on the user feedback, the diagram module 218 can verify the accuracy of a diagram reading, symbol identification, or the like. This confidence factor or score can be input into additional calculations, described below.

In one embodiment, the diagram module 218 includes line tracing logic where the diagram module 218 takes one-line or other power engineering diagrams and searches or looks for electrical system components that are necessary, required, or otherwise likely to be needed for an element, e.g., equipment. The diagram module 218, in such an embodiment, accesses an existing knowledge set of which elements, e.g., equipment, are necessarily or commonly found with other elements. For example, if a generator symbol is found, the diagram module 218 traces or follows the electrical line looking for a transformer because generators are typically paired with a transformer, as well as relays and other equipment. In one embodiment, the data set that the diagram module 218 uses for line tracing is extensible, e.g., based on user input, reading the data set from a file, or the like.

In one embodiment, the diagram module 218 makes copies of one-line and other power engineering diagrams and, for every item on the diagrams, it highlights the item it has recognized in the respective copies and makes that information part of the compliance reports, e.g., via the report module 212. In this manner, the diagram module 218 makes visual enhancements to the diagrams for greater system understanding. Utility personnel can quickly identify areas that are not recognized, which may be remedied through UIRA requests or other feedback. Further, visually (or with other indications), the diagram module 218 may draw a box or highlighted area showing the items that were recognized or parsed, in logical groupings, locations, or per other criteria.

In one embodiment, the diagram module 218 creates an interactive display and control using arbitrary power engineering diagrams as active interfaces. After the diagram module 218 reads a diagram, the equipment and settings information that was set forth in the diagram becomes active. By color, highlight, or other indicator, the diagram module 218 indicates equipment that has been checked or audited. In response to clicking or selecting an equipment item on the diagram, the diagram module 218 can run a new audit, indicate which further compliance steps have been performed, and/or indicate additional data sets associated with the equipment. Further, in one embodiment, the diagram module 218 can indicate a list of all applicable reliability standards for the particular equipment.

In one embodiment, the inventory module 220 can also be utilized for global inventory discovery. In one embodiment, the inventory module 220 can automatically catalog the specific equipment for NERC/FERC regulatory compliance, by taking input from a variety of data sources, including inventory management systems, databases, diagrams and filesystems, among others. Because of the standard format of the regulatory standards, a first estimate of applicable standards (R1 . . . . Rn) based on the particular utility's equipment and configuration, a data set of relevant equipment, and potential gaps can be generated. With the estimate of applicable standards and equipment, the compliance cycle 214 can then create a timeline and schedule for the applicable standards. In one embodiment, the compliance cycle module 214 runs compliance cycles per the schedule for each reliability standard, as well as simulated audits of those reliability standards in SAM mode, as described above. As an alternative to automatic scheduling, compliance cycles and simulated audits can be presented to and then authorized by appropriate utility personnel.

In one embodiment, the live module 222 includes, monitors, provides, or the like, a live compliance state that can be continuously updated and monitored by utility personnel. In one embodiment, an internal variable determines whether compliance cycles for reliability standards are those that can be “run” continuously, or those that require further user input or delay. In other words, based on the time and steps necessary to run a compliance check on a reliability standard, the live module 222 can update nearly continuously, or at the update interval of the slowest compliance cycle for a reliability standard.

In one embodiment, the live module 222 provides a status of a live compliance state through an interface, e.g., the active utility interface or other display and control method. In addition, in one embodiment, an LLM and/or the compliance model provides a natural language assessment of the live compliance state at any time. Further, for each Standard, a “living” or dynamic RSAW, which the live module 222 updates in real-time during a compliance task, can be displayed, downloaded, or otherwise modified. In one embodiment, the live module 222 represents a significant advance in the state of the art in this area, as reliability issues may persist between ordinary compliance cycle timelines. These issues can be brought to the attention of utility personnel and/or the autonomy module 210, which can then take appropriate actions towards resolution.

In one embodiment, due to security concerns and the large-scale of utility systems there is no feasible way to get peer feedback in real time regarding reliability issues. However, in one embodiment, the security module 224 includes an anonymous data sharing mode under which trends in reliability standards issues can be shared among utilities that implement the compliance apparatus 104 as described herein. These trends can be provided in a list, or “heat map” showing certain reliability standards that are of concern in other utilities, without providing specifics of the reliability issues that were encountered or revealing the identities or location of the other utilities.

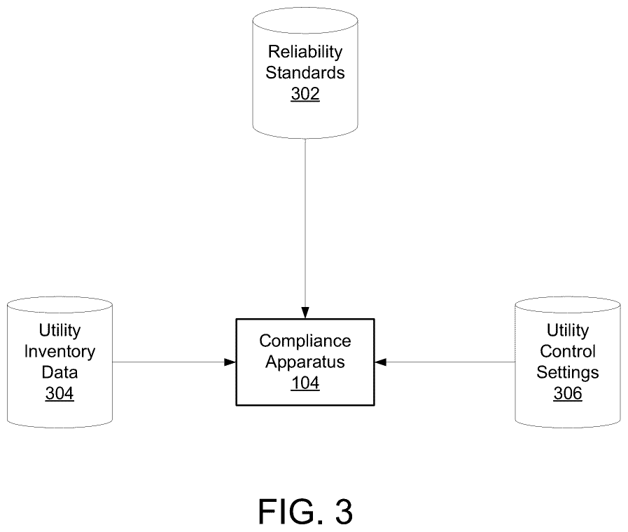

FIG. 3 depicts one embodiment of a universal compliance engine, as described herein. In one embodiment, the compliance apparatus 104, e.g., the UCE, receives reliability standards as input, parses the standards, and processes the parsed standards to create a compliance model, e.g., a learning model. The compliance apparatus 104, in one embodiment, also receives utility inventory data 304 and/or utility control settings data 306, which the compliance model may use to generate one or more compliance tasks for an organization or enterprise.

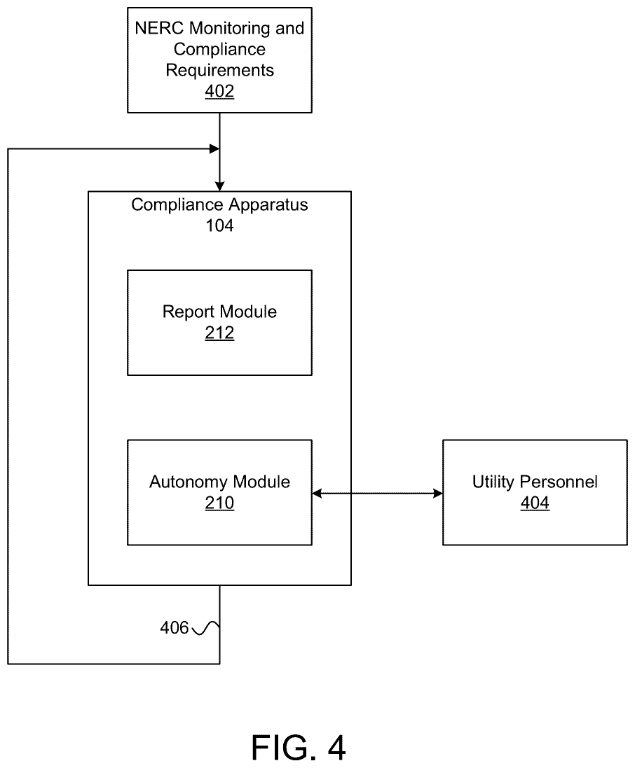

FIG. 4 depicts one embodiment of a universal compliance engine, as described herein. In one embodiment, NERC monitoring and compliance requirements/standards 402 are provided to the compliance apparatus 104, to be parsed and processed, as described herein, to create one or more compliance tasks. In one embodiment, the report module 212 creates monitoring reports and data sets that comply with the compliance requirements. In one embodiment, the autonomy module 210 is configured to trigger a compliance cycle for a compliance task, e.g., via the compliance cycle module 214, using information from one or more utility personnel 404, e.g., via a UIRA. Feedback 406 from the autonomy module 210 is provided back to the compliance apparatus 104 for further training of the compliance model, for reporting, for compliance cycle configuration, and/or the like.

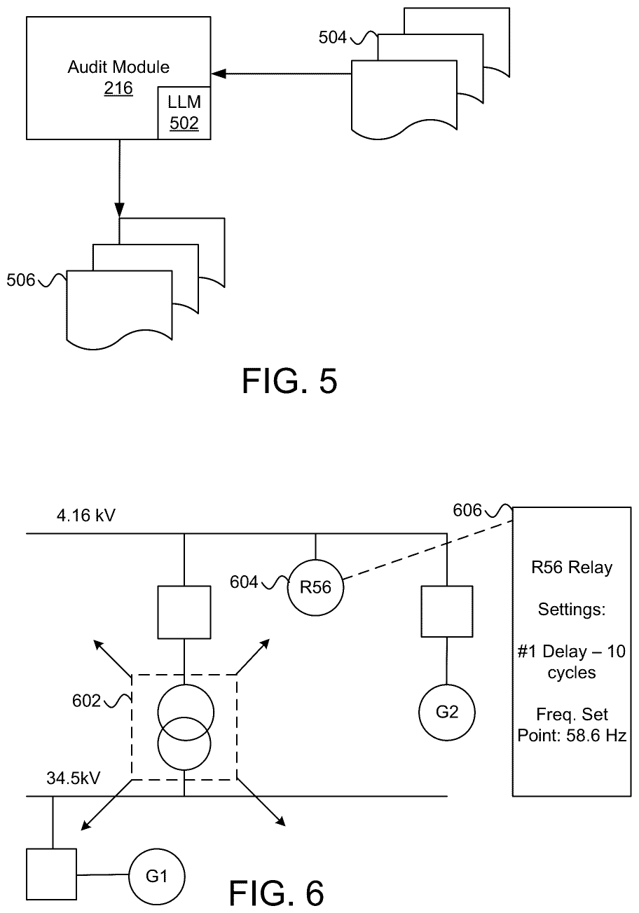

FIG. 5 depicts one embodiment of a content-dependent audit response, described herein. In one embodiment, the audit module 216 receives information such as text segments 504 (e.g., text information from previous compliance cycles such as violation notices) and provides or inserts the text segments 504 into an LLM 502, to create a context-dependent text 506 (dependent on the text segments that the LLM 402 processes) and suitable for filing with the RE that takes into account previous violations.

FIG. 6 depicts one embodiment of an electrical diagram. In one embodiment, the diagram module 218 reads electrical diagrams to identify information, elements, parts, settings, and/or the like using OCR, image processing, and/or the like. To do this, in one embodiment, the diagram module 218 identifies symbols that correspond to equipment in the utility's reliability equipment inventory. For an electrical utility, for example, common symbols may include generators, transformers, relays, and transmission lines, such as relay R56 604. These diagrams may include information, settings, parameters, and/or other data regarding the equipment they depict. For example, electric relays, e.g., relay R56 604, commonly include numerical designations for their under- and over-frequency “tripping” (circuit-breaking) settings. The diagram module 218, in one embodiment, identifies the symbols in an automated fashion and uses an “increasing radius” method 602 to search for and read appropriate numerical and mathematical symbols in proximity to each diagram element. Further, users may interact with the diagram to see additional information/settings, such as the information 606 associated with relay R56 604, in response to a click, tap, or the like.

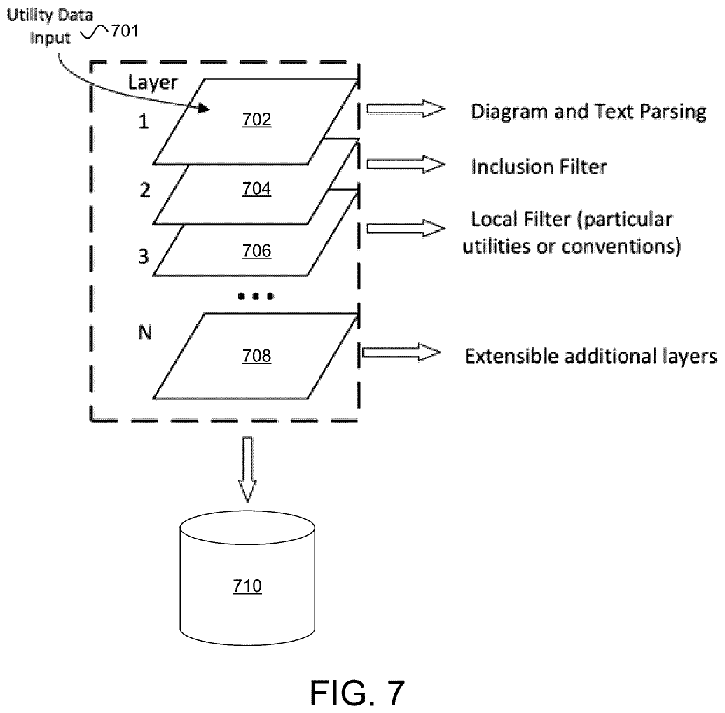

FIG. 7 depicts one embodiment of tiered equipment identification. In one embodiment, the tiered equipment identification includes a hierarchical, multi-layer processing filter that identifies pieces of equipment through a stepwise process. In one embodiment, at a first layer 702, the utility data module 206 receives and analyzes utility data input 701, including utility documents, such as schematics, network diagrams, or other documents. In one embodiment, the output of this layer is a database of identified equipment and associated characteristics, including device name, ID number(s), manufacturer, device type, style or model, and other attributes such as voltage, amps, resistance, RPM ratings, IP address and/or the like, depending upon the equipment type.

In the second layer 704, e.g., the “Inclusion Filter”, the utility data module 206 examines the output of the first layer more closely, reviewing for cases in which there is a lower confidence factor in the correspondence between the input data 701 and the resulting device classifications. In one embodiment, the utility data module 206 at Layer 3 706 applies a local filter of previously identified “local variations” in equipment labeling and classification, such as a particular way of drawing resistors or other power circuit elements. The local filter is dynamically adjusted over time, as the utility data module 206 learns how the documentation represents certain power system elements or particular ways in which equipment is drawn or labeled by the utility or its engineers. Various other layers 708 may be included, configured, or otherwise defined, e.g., by machine learning or user input. In one embodiment, the output 710 of the tiered equipment identification process includes a list, table, database, or the like of equipment identification and classification.

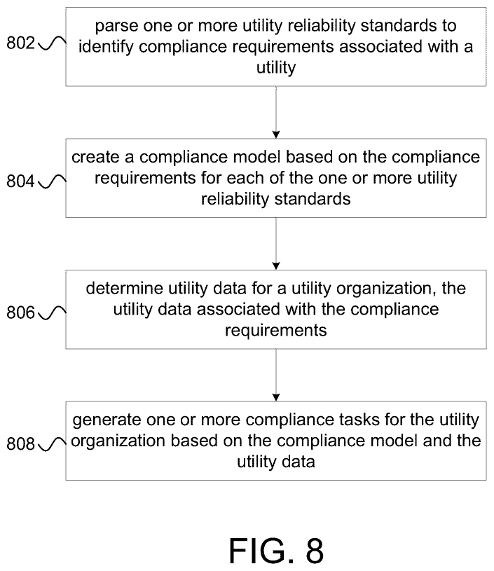

FIG. 8 depicts one embodiment of a method for a universal compliance engine. The method may be performed by an information handling device 102, a processor, an FPGA, a compliance apparatus 104, and/or the like. In one embodiment, the method begins and parses 802 one or more utility reliability standards to identify compliance requirements associated with a utility. In one embodiment, the method creates 804 a compliance model based on the compliance requirements for each of the one or more utility reliability standards. In one embodiment, the method determines 806 utility data for a utility organization, the utility data associated with the compliance requirements. In one embodiment, the method generates 808 one or more compliance tasks for the utility organization based on the compliance model and the utility data, and the method ends.

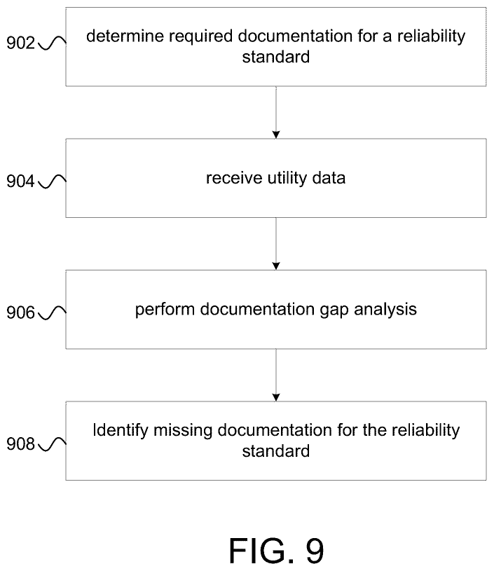

FIG. 9 depicts one embodiment of a method for a universal compliance engine. The method may be performed by an information handling device 102, a processor, an FPGA, a compliance apparatus 104, and/or the like. In one embodiment, the method begins and determines 902 the documentation that is required for a reliability standard. In one embodiment, the method receives 904 utility data associated with a reliability standard. In one embodiment, the method performs 906 documentation gap analysis based on the required documentation and the utility data for the reliability standard. In one embodiment, the method identifies 908 missing documentation for the reliability standard, and the method ends.

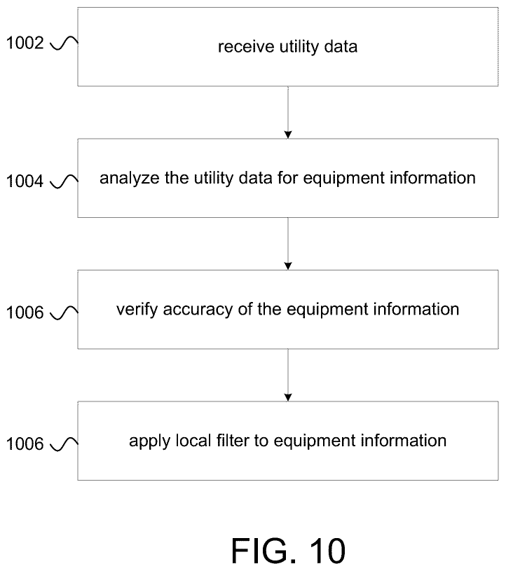

FIG. 10 depicts one embodiment of a method for tiered equipment identification. The method may be performed by an information handling device 102, a processor, an FPGA, a compliance apparatus 104, and/or the like. In one embodiment, the method begins and receives 1002 utility data, e.g., equipment data, settings data, or the like. In one embodiment, the method analyzes 1004 the utility data for equipment information. In one embodiment, the method verifies 1006 the accuracy of the equipment information. In one embodiment, the method applies 1008 a local filter to the equipment information, and the method ends.

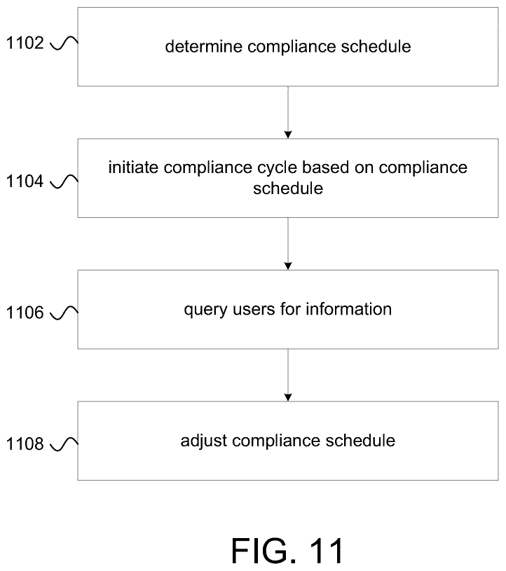

FIG. 11 depicts one embodiment of a method for initiating a compliance cycle. The method may be performed by an information handling device 102, a processor, an FPGA, a compliance apparatus 104, and/or the like. In one embodiment, the method begins and determines 1102 a compliance schedule for a compliance task. In one embodiment, the method initiates 1104 a compliance cycle based on the compliance schedule. In one embodiment, the method queries 1106 users for additional information during the compliance cycle. In one embodiment, the method dynamically adjusts 1108 the compliance schedule for the compliance cycle based on the information from the users and/or other extrinsic information, and the method ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
at least one memory; and
at least one processor coupled with the at least one memory and configured to cause the apparatus to:
parse one or more utility reliability standards to identify compliance requirements associated with a utility;
create a compliance model based on the compliance requirements for each of the one or more utility reliability standards;
determine utility data for a utility organization, the utility data associated with the compliance requirements; and
generate one or more compliance tasks for the utility organization based on the compliance model and the utility data.

2. The apparatus of claim 1, wherein the at least one processor is configured to cause the apparatus to generate a best fit model between the utility data for the utility organization and the compliance requirements.

3. The apparatus of claim 1, wherein the utility data comprises equipment data, inventory data, or a combination thereof.

4. The apparatus of claim 1, wherein the at least one processor is configured to cause the apparatus to generate compliance reports based on the one or more compliance tasks.

5. The apparatus of claim 4, wherein the at least one processor is configured to cause the apparatus to calculate a confidence score for the compliance reports.

6. The apparatus of claim 4, wherein the at least one processor is configured to cause the apparatus to perform documentation gap analysis to determine whether the generated compliance reports comply with documentation requirements for the utility reliability standards.

7. The apparatus of claim 1, wherein the at least one processor is configured to cause the apparatus to generate a compliance schedule for the one or more compliance tasks.

8. The apparatus of claim 7, wherein the at least one processor is configured to cause the apparatus to initiate a compliance cycle based on the compliance schedule.

9. The apparatus of claim 8, wherein the compliance cycle has an associated tolerance level associated with completion of the compliance cycle.

10. The apparatus of claim 8, wherein the at least one processor is configured to cause the apparatus to query personnel associated with the utility organization during the compliance cycle.

11. The apparatus of claim 7, wherein the at least one processor is configured to cause the apparatus to dynamically adjust the compliance schedule based on output from a previous compliance cycle and extrinsic compliance data.

12. The apparatus of claim 1, wherein the at least one processor is configured to cause the apparatus to reconcile missing utility data associated with the compliance requirements.

13. The apparatus of claim 1, wherein the at least one processor is configured to cause the apparatus to generate a compliance audit response in response to an audit request.

14. The apparatus of claim 1, wherein the at least one processor is configured to cause the apparatus to parse engineering diagrams as part of the one or more compliance tasks to identify utility equipment associated with the one or more compliance tasks.

15. The apparatus of claim 14, wherein the at least one processor is configured to cause the apparatus to verify an accuracy of the parsed engineering diagrams and request additional information if the accuracy does not satisfy a threshold accuracy.

16. The apparatus of claim 15, wherein the at least one processor is configured to cause the apparatus to incorporate custom classification data for the parsed engineering diagrams.

17. The apparatus of claim 14, wherein the at least one processor is configured to cause the apparatus to convert utility equipment information from the parsed engineering diagrams to match local utility equipment information.

18. The apparatus of claim 14, wherein the at least one processor is configured to cause the apparatus to generate a catalog of utility equipment associated with each of the one or more compliance tasks based on one or more inputs.

19. The apparatus of claim 18, wherein the at least one processor is configured to cause the apparatus to dynamically adjust a compliance cycle for a compliance task based on the catalog of utility equipment associated with each of the one or more compliance tasks.

20. The apparatus of claim 14, wherein the at least one processor is configured to cause the apparatus to generate an interactive engineering diagram based on the compliance model and the parsed engineering diagrams.

21. The apparatus of claim 1, wherein the at least one processor is configured to cause the apparatus to generate one or more executable rules for the one or more compliance tasks, each of the one or more executable rules comprising one or more steps that trigger one or more actions for maintaining compliance with the one or more utility reliability standards.

22. A method, comprising:
parsing one or more utility reliability standards to identify compliance requirements associated with a utility;
creating a compliance model based on the compliance requirements for each of the one or more utility reliability standards;
determining utility data for a utility organization, the utility data associated with the compliance requirements; and
generating one or more compliance tasks for the utility organization based on the compliance model and the utility data.

23. A computer program product, comprising a computer readable storage medium storing code, the code being configured to be executable by a processor to perform operations comprising:
parsing one or more utility reliability standards to identify compliance requirements associated with a utility;
creating a compliance model based on the compliance requirements for each of the one or more utility reliability standards;
determining utility data for a utility organization, the utility data associated with the compliance requirements; and
generating one or more compliance tasks for the utility organization based on the compliance model and the utility data.
